(19) United States
(12) Patent Application Publication
(10) Pub. No.: US 2024/0220833 A1
(43) Pub. Date: Jul. 4, 2024

(54) METHOD FOR PREDICTING USAGE FOR CLOUD STORAGE SERVICE AND SYSTEM THEREFOR

(71) Applicant: SAMSUNG SDS CO., LTD., Seoul (KR)

(72) Inventors: Hyo Jung LEE, Seoul (KR); Jeong Hyun LEE, Seoul (KR); Seung Wan HAN, Seoul (KR); Sung Hoon CHOI, Seoul (KR)

(73) Assignee: SAMSUNG SDS CO., LTD., Seoul (KR)

(21) Appl. No.: 18/382,733

(22) Filed: Oct. 23, 2023

(30) Foreign Application Priority Data
Dec. 29, 2022 (KR) 10-2022-0189851

(51) Int. Cl. G06N 7/00; G06N 20/00

(52) U.S. Cl. CPC G06N 7/00; G06N 20/00

(57) ABSTRACT

Provided are a method for predicting usage for cloud storage service and system therefor. The method according to some embodiments may include obtaining a time series dataset through monitoring usage of storage resource, extracting a plurality of candidate training sets from the time series dataset, evaluating suitability of the plurality of candidate training sets to a linear regression model, wherein an independent variable of the linear regression model comprises a time variable and a dependent variable represents usage of the storage resource; selecting a training set from the plurality of candidate training sets based on the evaluation result, and predicting future usage of the storage resource through the linear regression model trained with the training set.

### CROSS-REFERENCE TO RELATED APPLICATION

This application claims the benefit of Korean Patent Application No. 10-2022-0189851, filed on Dec. 29, 2022, in the Korean Intellectual Property Office, the disclosure of which is incorporated herein by reference in its entirety.

### BACKGROUND

### 1. Field

The present disclosure relates to a method for predicting usage for cloud storage service and system therefor. More specifically, it relates to a method for predicting future usage of storage resources to operate a cloud storage service more efficiently and a system for performing the method.

### 2. Description of the Related Art

As cloud technology matures, many cloud service providers are providing cloud storage services, and many users are using cloud storage services.

In order to operate cloud storage services efficiently (i.e., operate storage resources efficiently), technology to predict future usage of storage resources is essential. If resource usage may not be predicted in advance, it will inevitably cause inconvenience to users or reduce the efficiency of resource operation due to idle storage resources.

For example, if the usage of storage resource suddenly exceeds the limit, users will not be able to upload additional data and will inevitably experience inconvenience in using the service. Additionally, if a cloud service provider expands storage in advance to prevent such inconveniences, the efficiency of resource operation will inevitably decrease due to excessive idle storage resources.

### SUMMARY

The technical problem to be solved through some embodiments of the present disclosure is to provide a method for accurately predicting future usage of storage resource when providing a cloud storage service and a system for performing the method.

Another technical problem to be solved through some embodiments of the present disclosure is to provide a method for reducing computing costs required to predict future usage of storage resource.

The technical problems of the present disclosure are not limited to the technical problems mentioned above, and other technical problems not mentioned may be clearly understood by those skilled in the art from the description below.

According to some embodiments of the present disclosure, there is provided a method for predicting usage for cloud storage service performed by at least one computing device. The method may include: obtaining a time series dataset through monitoring usage of storage resource: extracting a plurality of candidate training sets from the time series dataset: evaluating suitability of the plurality of candidate training sets to a linear regression model, wherein an independent variable of the linear regression model comprises a time variable and a dependent variable represents usage of the storage resource: selecting a training set from the plurality of candidate training sets based on the evaluation result; and predicting future usage of the storage resource through the linear regression model trained with the training set.

In some embodiments, the extracting the plurality of candidate training sets may include: dividing the time series dataset into a plurality of partial datasets: extracting the most recent partial dataset among the plurality of partial datasets as a first candidate training set; and extracting other partial dataset different from the most recent partial dataset as a second candidate training set.

In some embodiments, the other partial dataset may be a neighboring dataset of the most recent partial dataset.

In some embodiments, the evaluating the suitability of the plurality of candidate training sets may include: evaluating suitability of the first candidate training set using a linear regression model for evaluation trained with the first candidate training set; additionally training the linear regression model for evaluation with the other partial dataset; and evaluating suitability of the second candidate training set using the additionally trained linear regression model.

In some embodiments, suitability of each of the plurality of candidate training sets may be evaluated based on a determination coefficient of a linear regression model for evaluation trained with a candidate training set.

In some embodiments, the evaluating the suitability of the plurality of candidate training sets may include: evaluating suitability of a specific candidate training set based on a residual of a linear regression model for evaluation for the specific candidate training set.

In some embodiments, the evaluating the suitability of the specific candidate training set may include: training the linear regression model for evaluation using a first partial dataset of the specific candidate training set; and calculating a residual of the linear regression model for evaluation using a second partial data set of the specific candidate training set different from the first partial data set.

In some embodiments, the training set may be a first training set selected from a first time series dataset generated through monitoring up to a first time point, the linear regression model may be a first linear regression model for predicting future usage after the first time point, the method further may include: selecting a second training set from a second time series dataset obtained through monitoring up to a second time point after the first time point, wherein the second time series dataset comprises additional dataset generated through monitoring after the first time point; and predicting future usage after the second time point through a second linear regression model trained with the second training set.

In some embodiments, learned parameters of a linear regression model for evaluation may be obtained during a process of determining the first training set are stored in a storage, the selecting the second training set may include: updating the learned parameters by learning the additional dataset: selecting the second training set by evaluating suitability of candidate training sets using the updated parameters and

storing the updated parameters in the storage.

In some embodiments, the predicting the future usage may include: predicting usage of the storage resource at a future time point by inputting a value indicating the future time point into the trained linear regression model.

In some embodiments, the predicting the future usage may include: predicting a time point when future usage of the storage resource reaches a specific amount through the trained linear regression model.

In some embodiments, the training set may be a dataset for a specific client, the predicting the future usage may include: predicting a time point when future usage of the storage resource allocated to the specific client reaches an allocated amount through the trained linear regression model; and allocating additional storage resource to the specific client before the predicted time point.

According to another embodiments of the present disclosure, there is provided a system for predicting usage for a cloud storage service. The system may include: one or more processors; and a memory for storing instructions, wherein the one or more processors, by executing the stored instructions, perform operations including: obtaining a time series dataset through monitoring usage of storage resource: extracting a plurality of candidate training sets from the time series dataset: evaluating suitability of the plurality of candidate training sets to a linear regression model, wherein an independent variable of the linear regression model comprises a time variable and a dependent variable represents usage of the storage resource: determining at least one training set from the plurality of candidate training sets based on the evaluation result; and predicting future usage of the storage resource through the linear regression model trained with the at least one training set.

In some embodiments, the extracting the plurality of candidate training sets may include: dividing the time series dataset into a plurality of partial datasets: extracting the most recent partial dataset among the plurality of partial datasets as a first candidate training set; and extracting other partial dataset different from the most recent partial dataset as a second candidate training set.

In some embodiments, suitability of each of the plurality of candidate training sets may be evaluated based on a determination coefficient of a linear regression model for evaluation trained with a candidate training set.

In some embodiments, the evaluating the suitability of the plurality of candidate training sets may include: evaluating suitability of a specific candidate training set based on a residual of a linear regression model for evaluation for the specific candidate training set.

In some embodiments, the predicting the future usage may include: predicting usage of the storage resource at a future time point by inputting a value indicating the future time point into the trained linear regression model; and predicting a time point when future usage of the storage resource reaches a specific amount through the trained linear regression model.

According to yet another embodiments of the present disclosure, there is provided a computer program combined with a computing device, wherein the computer program is stored on a computer-readable recording medium for executing steps including: obtaining a time series dataset through monitoring usage of storage resource: extracting a plurality of candidate training sets from the time series dataset: evaluating suitability of the plurality of candidate training sets to a linear regression model, wherein an independent variable of the linear regression model comprises a time variable and a dependent variable represents usage of the storage resource: determining at least one training set from the plurality of candidate training sets based on the evaluation result; and predicting future usage of the storage resource through the linear regression model trained with the at least one training set.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exemplary diagram for describing a cloud storage service providing system according to some embodiments of the present disclosure:

FIG. 2 is an exemplary diagram for describing an implementation method of a storage node according to some embodiments of the present disclosure:

FIGS. 3 and 4 are exemplary diagrams for schematically describing the operation of a usage prediction system according to some embodiments of the present disclosure:

FIG. 5 is an example flowchart schematically illustrating a method for predicting usage for a cloud storage service according to some embodiments of the present disclosure:

FIG. 6 is an exemplary diagram illustrating a method for predicting future usage of storage resources according to some embodiments of the present disclosure:

FIG. 7 is an example flowchart showing a training set selection method according to some embodiments of the present disclosure:

FIGS. 8 and 9 are exemplary diagrams further describing a training set selection method according to some embodiments of the present disclosure:

FIGS. 10 to 12 are exemplary diagrams describing a method for preventing duplicate training of a linear regression model according to some embodiments of the present disclosure; and

FIG. 13 illustrates an example computing device that may implement a usage prediction system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various embodiments of the present disclosure will be described in detail with reference to the attached drawings.

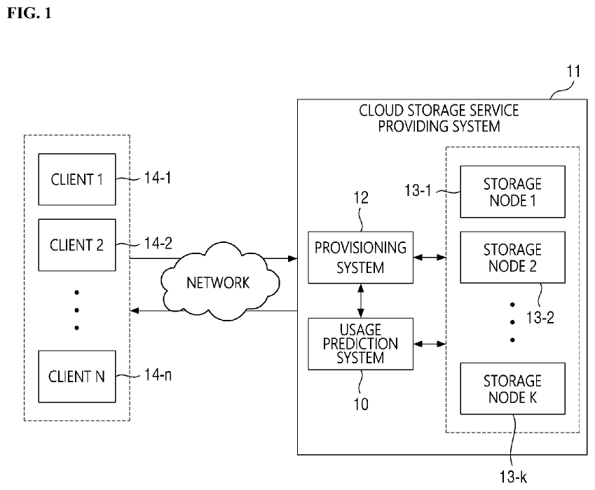

FIG. 1 is an exemplary diagram for describing a cloud storage service providing system 11 according to some embodiments of the present disclosure.

As shown in FIG. 1, the cloud storage service providing system 11 according to embodiments may be a system that provides storage services to a plurality of clients 14-1 to 14-n. For example, the cloud storage service providing system 11 may provide a cloud storage service by allocating/provisioning storage resources in response to requests from clients 14-1 to 14-n (e.g., virtual storage is allocated). Hereinafter, for convenience of description, the reference number ‘14’ will be used both when referring to an arbitrary client (e.g., 14-1) or when referring collectively to all clients (14-1 to 14-n). Additionally, hereinafter, the term storage resource may be abbreviated as ‘resource’ or ‘storage.’

As shown, the cloud storage service providing system 11 may be configured to comprise a usage prediction system 10, a provisioning system 12, and a plurality of storage nodes 13-1 to 13-k. Hereinafter, each component of the cloud storage service providing system 11 will be described. However, for convenience of description, the reference number ‘13’ is used both when referring to an arbitrary storage node (e.g., 13-1) or when referring collectively to all storage nodes (13-1 to 13-k).

The provisioning system 12 may be a computing system that allocates/provisions storage resource. The provisioning system 12 may allocate storage resource in response to a request from a client 14. For example, the provisioning system 12 may allocate total storage resource requested by the client 14 (i.e., the entire contracted capacity) at once. Alternatively, the provisioning system 12 may allocate only a portion of the storage resource requested by the client 14 (i.e., a portion of the contracted capacity) and may allocate the remaining storage resource at an appropriate time based on the results of predicting future usage of the allocated storage resource. In this case, operational efficiency for storage resource may be further improved.

In some cases, the provisioning system 12 may be named as ‘provisioning module,’ ‘provisioning unit,’ ‘provisioner,’ ‘provisioning device,’ etc.

Next, the storage node 13 may refer to a logical or physical node that provides storage resource. The storage node 13 may be implemented in any way as long as it may provide an independent storage space (resource) for each client 14. In some cases, the storage node 13 may be named such as ‘storage device/server,’‘storage module,’ ‘computing node,’ ‘resource node,’ ‘resource device,’ etc.

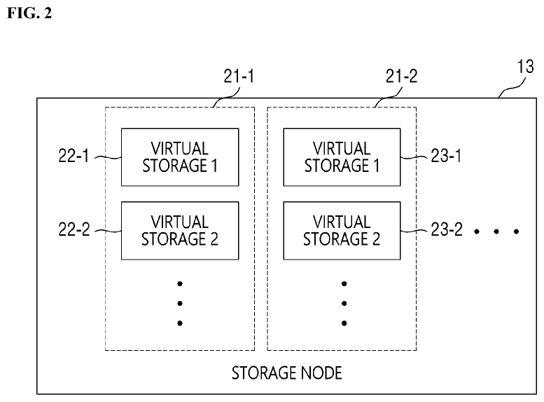

In some embodiments, as shown in FIG. 2, the physical storage node 13 may be implemented to comprise a plurality of virtual storages 22-1, 22-2, etc. For example, within the physical storage node 13, multiple virtual storage groups (21-1, 21-2, etc.) may be implemented, and multiple virtual storage groups (22-1, 22-2, 23-1, etc.) may form one virtual storage group (21-1, 21-2, etc.). At this time, virtual storage (e.g., 22-1) may mean the smallest unit of storage resource that may be allocated to the client 14. In this case, the provisioning system 12 may operate by allocating an appropriate number of virtual storages (e.g., 22-1) according to the capacity requested by the client 14. According to the present embodiments, the convenience of operating and managing storage resource may be improved.

In some cases, virtual storage (e.g., 22-1) may be named as ‘logical storage,’ ‘virtual storage node,’ ‘volume,’ etc.

Next, the usage prediction system 10 may be a computing system that may predict future usage of storage resource. For example, the usage prediction system 10 may monitor the usage (e.g., usage capacity, usage rate, etc.) of storage resource (e.g., allocated storage resource) provided by the storage nodes 13, and predict future usage of the storage resource based on the monitoring results. In some cases, the usage prediction system 10 may be named as ‘usage prediction module,’ ‘usage prediction unit/predictor,’ ‘usage prediction device,’ etc. Hereinafter, for convenience of description, the usage prediction system 10 will be abbreviated as ‘prediction system 10.’

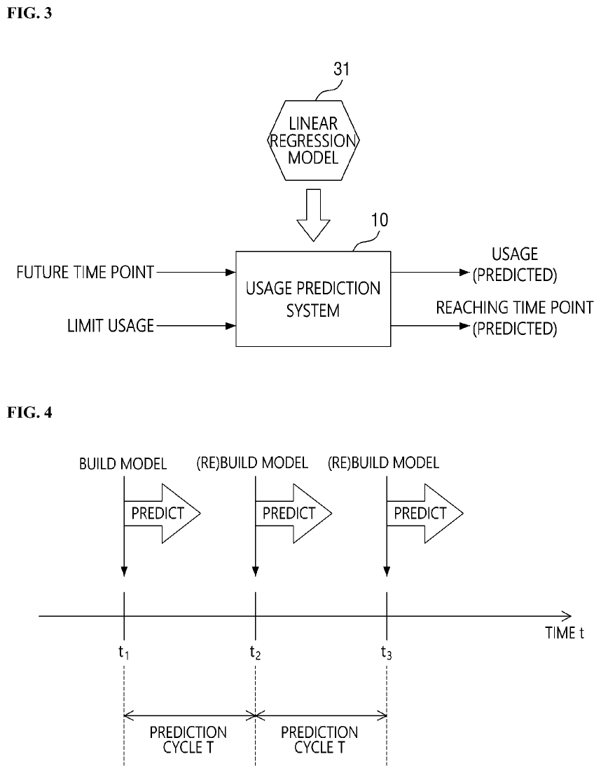

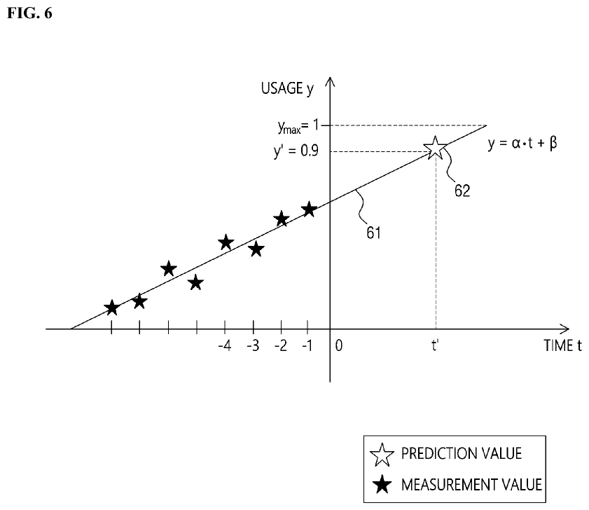

Specifically, as shown in FIG. 3, the prediction system 10 may predict future usage of storage resource through a linear regression model 31. For example, the prediction system 10 may predict resource usage (i.e., storage resource usage) at a future time point by inputting a value indicating the future time point into the trained linear regression model 31. Alternatively, the prediction system 10 may predict the time point (or the reaching period) when the future usage of storage resource reaches a specific amount (e.g., limit usage) through the trained linear regression model 31. This will be further described later with reference to FIG. 6 and the like.

The linear regression model 31 may be a model that has a time variable as an independent variable (or predictive/explanatory variable) and usage as a dependent variable (or response variable). The reason for modeling this is because storage resource usage usually tends to increase linearly over time. In other words, since the data of the client 14 has a tendency to continuously accumulate, and the amount of data storage does not increase exponentially unless in special cases (e.g., large-capacity backup, etc.), the linear regression model 31 as above may be viewed as a model that best represents changes in usage of storage resource.

The linear regression model 31 may be a simple linear regression model or a multiple linear regression model. In the following, for convenience of understanding, the explanation is made assuming that the linear regression model 31 is a ‘simple linear regression model.’

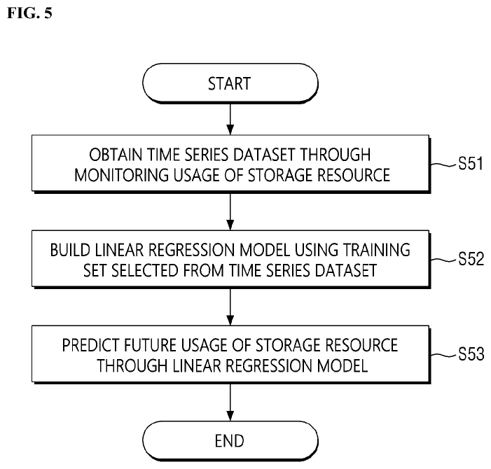

The method for the prediction system 10 building the linear regression model 31 will be described in detail later with reference to the drawings of FIG. 5 and other drawings.

Meanwhile, the prediction system 10 may rebuild the linear regression model 31 periodically or aperiodically. For example, as shown in FIG. 4, the prediction system 10 may rebuild the linear regression model 31 by reflecting recent monitoring data according to a preset prediction cycle/period (see ‘T’). By doing so, prediction accuracy for future usage of storage resource may be maintained at a consistently high level.

Here, the prediction (reconstruction) cycle (see ‘T’) may be a fixed value or a value that may vary depending on the situation. For example, as the usage of overall storage resource (or storage resource allocated to a specific client) increases, the prediction system 10 may set the prediction cycle to a smaller value. As another example, if the usage of total storage resource is equal to or greater than the reference value or if the increase/decrease in total storage resources or the number of requests from the client 14 increases rapidly, the prediction system 10 may set the prediction cycle to a smaller value.

The above-described prediction system 10 may be implemented with at least one computing device. For example, all of the functionality of prediction system 10 may be implemented in a single computing device. Alternatively, a first function of prediction system 10 may be implemented in a first computing device and a second function may be implemented in a second computing device. Alternatively, certain functions of the prediction system 10 may be implemented on a plurality of computing devices.

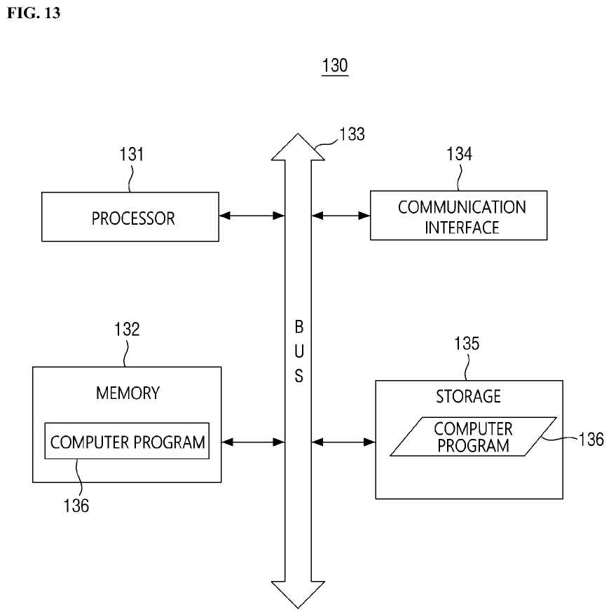

A computing device may include any device equipped with a computing (processing) function, and an example of such a device may be referred to FIG. 13.

So far, the configuration and operation of the cloud storage service providing system 11 according to some embodiments of the present disclosure have been described with reference to FIGS. 1 to 4. Hereinafter, various methods that may be performed in the prediction system 10 will be described with reference to FIG. 5.

Hereinafter, in order to provide convenience of understanding, the description will be continued assuming that the methods to be described later are performed in the prediction system 10 in the environment illustrated in FIG. 1. Additionally, the description will be continued assuming that all steps/operations of the methods to be described later are performed by the prediction system 10. Accordingly, if the subject of a specific step/operation is omitted, it may be understood as being performed in the prediction system 10. However, in a real environment (or an environment other than that illustrated in FIG. 1), some steps/operations of the method to be described later may be performed on another computing device.

FIG. 5 is an example flowchart schematically illustrating a method for predicting usage for a cloud storage service according to some embodiments of the present disclosure. However, this is only an example embodiment for achieving the purpose of the present disclosure, and some steps may be added or deleted as needed.

As shown in FIG. 5, the usage prediction method according to embodiments may begin at step S51 of obtaining a time series dataset through monitoring the usage of storage resource. The obtained time series dataset may be stored in a storage.

Here, a time series dataset may be composed of a plurality of samples (i.e., measurement samples), and samples may be named in the technical field as ‘instance,’ ‘observation,’ ‘example,’ or ‘individual data.’ For reference, monitoring data is usage data measured dependent on time, so it may be understood as time series data.

For example, the prediction system 10 may monitor the total usage of storage resource (e.g., the usage of storage resource provided by all storage nodes 13 or the usage of storage resource of all clients 14), and resource usage by each storage node 13, each virtual storage (e.g., 22-1), each virtual storage group (e.g., 21-1), and/or each client 14. However, the present invention is not limited thereto. Here, the usage of storage resource may refer to the usage of pre-allocated storage resource, but is not limited thereto.

The above-described resource usage (i.e., storage resource usage) may be measured (monitored), for example, at preset unit times (i.e., cycle). At this time, the resource usage may be a value measured at a specific time point, or it may be an average value of the usage for a unit time. Additionally, the unit time may be a preset fixed value or a value that changes depending on the situation. For example, if the usage of storage resource is equal to or greater than a reference value, or the increase/decrease in storage resource usage or the number of requests from the client 14 increases rapidly, the prediction system 10 may set the unit time to a smaller value for more accurate monitoring. In the opposite case, the unit time may be set to a larger value.

For reference, the usage of storage resource may be measured in the ratio (i.e., usage rate) units (e.g., used capacity compared to total capacity, used capacity compared to allocated capacity, etc.) or may be measured in capacity units.

In step S52, a linear regression model may be built (trained) using a training set selected from the time series dataset. Since those skilled in the relevant technical field are already familiar with the method of building (training) a linear regression model (i.e., updating the parameters of the linear regression model based on training errors), description of this is omitted.

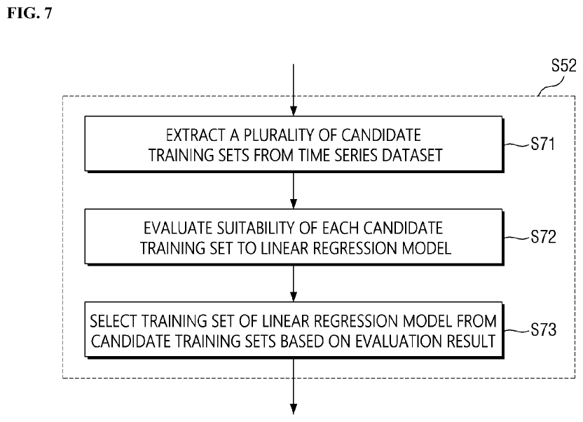

In some embodiments, a training set may be selected from a time series dataset based on the suitability to a linear regression model. And, a linear regression model may be built with the selected training set. By doing so, prediction accuracy for future usage may be improved, which will be described in detail with reference to FIGS. 7 to 9 later.

In step S53, future usage of storage resource may be predicted through a linear regression model. For example, the prediction system 10 may predict the usage of storage resource at a future time point, or may predict the time point or the period (time) when the usage of storage resource reaches a specific amount (e.g., limit usage). In order to provide easier understanding, further description will be given with reference to FIG. 6.

The straight line 61 shown in FIG. 6 refers to the graph of the trained linear regression model, and ‘α’ and ‘β’ in the formula of the graph refer to the parameters of the linear regression model. FIG. 6 assumes that the measurement time unit of resource usage is ‘1,’ and the time point ‘t=0’ means the current (predicted) time point.

As shown in FIG. 6, the prediction system 10 may predict usage at a future time point by inputting a value (e.g., t′, etc.) indicating the future time point into the trained linear regression model (i.e., formula).

Alternatively, the prediction system 10 may predict the time point (e.g., t′) or period (e.g., t′) when the usage of storage resource reaches a specific amount (e.g., limit usage y′) through the trained linear regression model (i.e., formula). For example, if the measurement time unit of resource usage is ‘T,’ the prediction system 10 may predict the reaching point (or period) based on Equation 1 below. Those skilled in the relevant technical field may understand Equation 1 below without difficulty, so its explanation will be omitted.

$$T \cdot {t}^{′} = \frac{{y}^{′} - β}{α} \qquad [ Equation 1 ]$$

Meanwhile, prediction results about future usage of storage resource may be used in various ways.

In some embodiments, the prediction system 10 may predict the time point and/or period when future usage of total storage resource reaches a limit usage (e.g., 90%). Additionally, the prediction system 10 may notify the administrator of the cloud storage service providing system 11 of the prediction result before the reaching time point approaches. By doing so, storage expansion may be accomplished at the appropriate time.

In some other embodiments, the prediction system 10 may predict the time point and/or period when future usage of storage resource allocated to a specific client 14 reaches an allocated amount. Additionally, the prediction system 10 may provide the prediction result to the provisioning system 12 before the reaching time point approaches. Then, the provisioning system 12 may allocate additional storage resource to the client 14 before the reaching time point. For example, the provisioning system 12 may allocate additional storage resources to the client 14 within the contracted capacity. By doing so, problems, in which the client 14 experiences inconvenience in using the service, may be prevented in advance, and storage resource may be operated more efficiently.

In addition, although not clearly shown in FIG. 5, the above-described steps S51 to S53 may be repeatedly performed periodically or aperiodically. For example, the prediction system 10 may rebuild a linear regression model according to a preset prediction cycle. More specifically, the prediction system 10 may use a first time series dataset generated through monitoring up to a first time point (e.g., using the selected first training set) to build the first linear regression model used to predict future usage after the first time point. And, the prediction system 10 may use a second time series dataset (here, the second time series dataset is a recent/additional data set generated through monitoring after the first time point) generated through monitoring up to a second time point after the first time point (e.g., using the selected second training set) to build a second linear regression model used to predict future usage after the second time point. These processes may be performed continuously and repeatedly.

It may be understood that the reason for repeatedly rebuilding the linear regression model is that the future usage of storage resource is likely to be determined by recent usage and their change trends (i.e., the recent dataset based on the prediction time point may be viewed as the most important data for predicting future usage).

So far, a usage prediction method for a cloud storage service according to some embodiments of the present disclosure has been described with reference to FIGS. 5 and 6. According to the above, the future usage of storage resource may be accurately predicted through a linear regression model with a time variable and a usage variable. Additionally, by rebuilding the linear regression model periodically or aperiodically, prediction accuracy for future usage may be maintained at a consistently high level.

Hereinafter, a training set selection method according to some embodiments of the present disclosure will be described with reference to FIGS. 7 to 9.

FIG. 7 is an example flowchart showing a training set selection method according to some embodiments of the present disclosure. However, this is only an example embodiment for achieving the purpose of the present disclosure, and some steps may be added or deleted as needed.

As shown in FIG. 7, the training set selection method according to embodiments may begin at step S71 of extracting a plurality of candidate training sets from a time series dataset. For example, the prediction system 10 may divide a time series dataset into a plurality of partial datasets. At this time, the size of the partial datasets (i.e., number of samples) may be the same or different. Additionally, the prediction system 10 may extract a plurality of candidate training sets from a plurality of partial datasets. However, the specific method may vary depending on the embodiment.

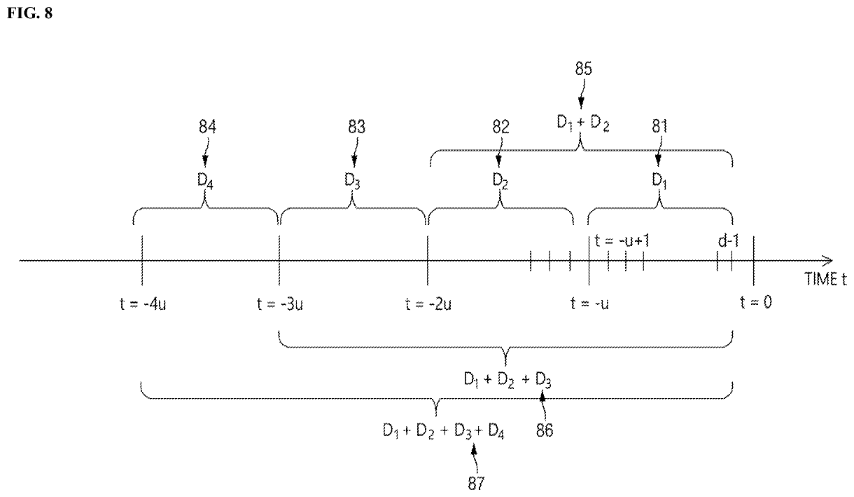

In some embodiments, as shown in FIG. 8, the prediction system 10 may extract the candidate training sets 81, 85-87 such that the most recent partial dataset 81 is commonly included in the candidate training sets 81, 85-87. For example, it is assumed that the prediction system 10 equally divides the entire time series dataset 87 into four partial datasets (81 to 84, hereinafter referred to as ‘first to fourth partial datasets’) (see number of samples ‘u’). In this case, the prediction system 10 may extract the first partial data set 81 composed of the most recent samples as the first candidate training set 81. And, the prediction system 10 may extract the first partial data set 81 and the second partial data set 82 adjacent thereto as the second candidate training set 82. The prediction system 10 may also extract the third candidate training set 86 and the fourth candidate training set 87 in a similar manner.

For reference, the reason for commonly including the most recent partial dataset 81 in the candidate training sets 81, 85 to 87 is that, as described above, the most recent partial dataset based on the prediction time point (e.g., refer to ‘t=0’) is the most important data for predicting the future usage.

This will be described again with reference to FIG. 7.

In step S72, the suitability of each candidate training set to the linear regression model may be evaluated. The reason for evaluating the suitability to the linear regression model is that the candidate training set that does not conform well to the linear increasing trend (i.e., the candidate training set with a low suitability to the linear regression model) has a high possibility of being a dataset (i.e., a low-quality dataset) including a lot of noise (e.g., samples generated due to measurement errors, etc.) considering the characteristics of the usage dataset.

The specific method of evaluating the suitability of the candidate training set in this step may vary depending on the embodiment.

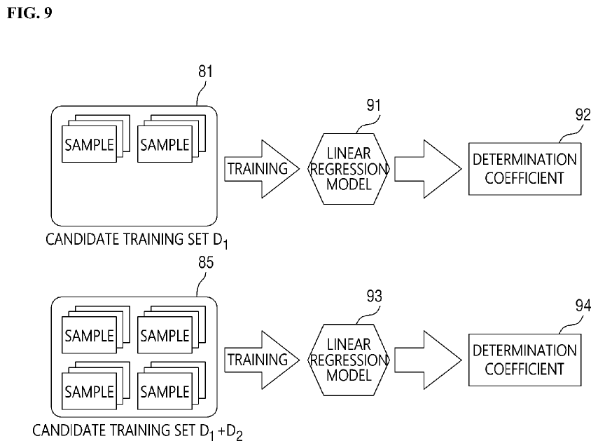

In some embodiments, the suitability of a candidate training set may be evaluated based on the determination coefficient of a linear regression model that learned the candidate training set. For example, as shown in FIG. 9, the prediction system 10 may trains a linear regression model 91 (that is, a linear regression model for evaluation) with the first candidate training set 81 and evaluate the suitability of the first candidate training set 81 based on the determination coefficient 92 of the trained linear regression model 91. For example, the prediction system 10 may evaluate the suitability of the first candidate training set 81 as being higher or calculate the suitability as a higher value, as the value of the determination coefficient is closer to ‘1.’ Similarly, the prediction system 10 may train the linear regression model 93 with the second candidate training set 85 and evaluate the suitability of the second candidate training set 85 based on the determination coefficient 95 of the trained linear regression model 93. Those skilled in the relevant technical field are already familiar with the method of calculating the determination coefficient and its meaning, so description thereof will be omitted.

In previous embodiments, the prediction system 10 may utilize additional training techniques to prevent redundant training. For example, referring again to FIGS. 8 and 9, when evaluating the suitability of the second candidate training set 85, the prediction system 10 does not train the linear regression model 93 with the second candidate training set 85, but may only perform additional training with the second partial dataset 82 on the previously trained linear regression model 91. By doing so, the computing cost required for the training set selection process may be greatly reduced.

In some other embodiments, the suitability of the candidate training set may be evaluated based on the residual (or error) of the linear regression model for the candidate training set (i.e., the linear regression model for evaluation). For example, the prediction system 10 may train a linear regression model with a specific candidate training set (e.g., 81) and calculate the residual (e.g., average residual, etc.) of the linear regression model trained using the same candidate training set (e.g., 81). As another example, the prediction system 10 may train a linear regression model with the first partial data set (e.g., 81) of a specific candidate training set (e.g., 85) and use the second partial data set (e.g., 82) to calculate the residual (e.g., average residual, etc.) of the linear regression model trained with the second partial data set (e.g., 82). At this time, the first partial dataset and the second partial dataset may be completely different or may include some common samples. Those skilled in the relevant technical field are already familiar with the residual calculation method (i.e., the difference between the predicted value and the actual value) and its meaning, so description of this will be omitted.

In some other embodiments, the suitability of the candidate training set may be evaluated based on various combinations of the above-described embodiments. For example, the prediction system 10 may calculate the first suitability according to the former embodiments, calculate the second suitability according to the latter embodiments, and evaluate the suitability of the candidate training set based on the weighted sum of the first suitability and the second suitability.

This will be described again with reference to FIG. 7.

In step S73, a training set of a linear regression model may be selected (determined) from a plurality of candidate training sets based on the evaluation result. For example, the prediction system 10 may determine a candidate training set with the highest suitability or at least one candidate training set with a suitability that is equal to higher than a reference value as the training set of the linear regression model.

For reference, if model training has already been performed during the process of selecting a training set suitable for a linear regression model, the prediction system 10 may predict future usage of storage resource by using the linear regression model for evaluation trained in the process as it is.

So far, a training set selection method according to some embodiments of the present disclosure has been described with reference to FIGS. 7 to 9. According to the above, the training set may be selected (determined) based on the evaluation result of the suitability of the candidate training set for the linear regression model. In this case, because a linear regression model may be trained using a relatively high-quality dataset, prediction accuracy for future usage may be further improved.

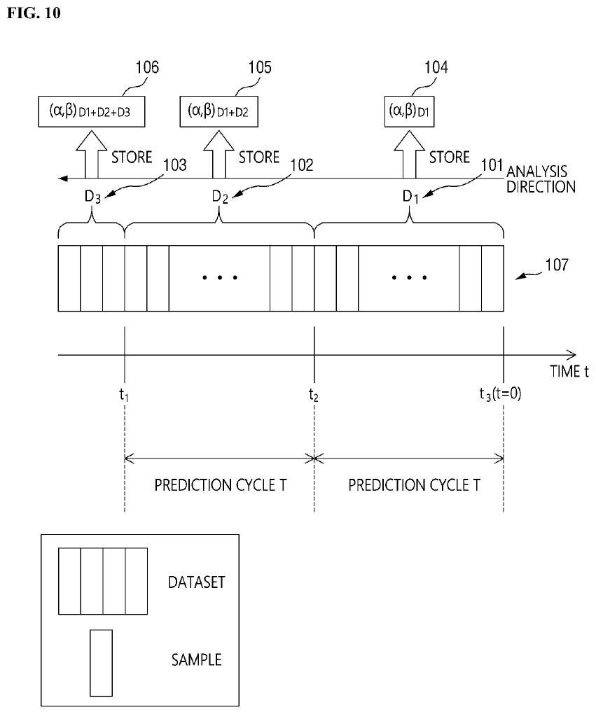

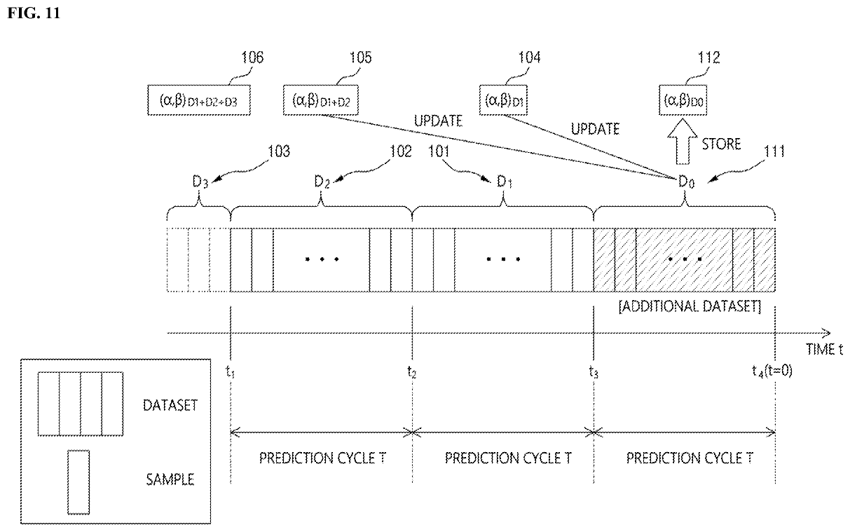

Meanwhile, according to what has been described so far, in order to evaluate the suitability of the candidate training set for the linear regression model, training on the linear regression model for evaluation needs to be repeatedly performed. Moreover, in order to accurately predict future usage, the linear regression model needs to be rebuilt repeatedly. Therefore, significant computing costs may be required for the candidate training set selection process and linear regression model building process. Hereinafter, embodiments of the present disclosure to alleviate this problem will be described with reference to FIGS. 10 to 12.

FIGS. 10 to 12 are exemplary diagrams for describing a method for preventing duplicate training of a linear regression model according to some embodiments of the present disclosure.

As shown in FIG. 10, the prediction system 10 may store the learned parameters 104 to 106 of the linear regression model for evaluation obtained during the process of evaluating the suitability of candidate training sets in a storage. Here, the learned parameters 104 to 106 refer to the linear regression model itself, so storing the learned parameters 104 to 106 may be understood as storing a model or a snapshot of the model.

For example, the prediction system 10 may perform regression analysis (i.e., model training) on the time series dataset 107 in the reverse direction (i.e., in the opposite direction of the time series direction) and store the learned parameters (104 to 106) in the storage in units of prediction cycles (see ‘T’). Specifically, the prediction system 10 may learn the first partial dataset 107 (e.g., which may correspond to part or all of the candidate training set) to derive the first parameters 104 of the linear regression model for evaluation, and perform additional learning on the second partial dataset 103 to derive the second parameters 105. The prediction system 10 may further derive the third parameters 106 in a similar manner and store the derived parameters 104 to 106 in the storage.

For reference, the time series dataset 107 shown in FIG. 10 may correspond to part or all of a candidate training set, or may correspond to a plurality of candidate training sets. This may vary depending on what value the prediction cycle (see ‘T’) is set to.

Next, as shown in FIG. 11, it is assumed that time has passed and the time point at which the prediction system 10 rebuilds the linear regression model (see ‘t4’) has arrived. And, it is assumed that an additional dataset 111 for the section between the previous time point (see ‘t3’) and the current time point (see ‘t4’) has been generated through monitoring.

In the above case, the prediction system 10 may minimize redundant training for the linear regression model for evaluation by updating the previously stored parameters 104 to 106 using the additional dataset 111.

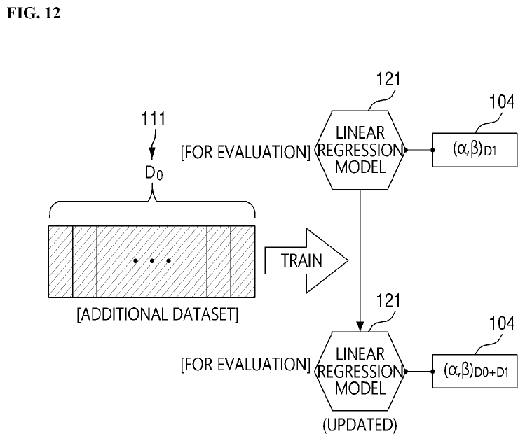

Specifically, the prediction system 10 may store the parameters 112 of the linear regression model for evaluation trained with the additional dataset 111 in the storage, and use the additional dataset 111 to update the previously stored parameters 104, 105. For example, as shown in FIG. 12, the prediction system 10 may initialize the linear regression model 121 for evaluation using the first parameters 104, and update the first parameters 104 by additionally training the corresponding linear regression model 121 with the additional dataset 111. The updated first parameters 104 may be stored back in the storage. In a similar manner, the prediction system 10 may also update second parameters 105.

Additionally, the prediction system 10 may evaluate the suitability of candidate training sets for the linear regression model to be rebuilt using the updated parameters (104, 105, etc.) and select the training set based on the evaluation results.

In addition, since monitoring data that has passed for a long time may have a negative impact on future usage predictions, the prediction system 10, whenever a certain time (period) elapses based on the time point of monitoring (generation/measurement), may remove related dataset 103 and parameters 106 from the storage. However, the scope of the present disclosure is not limited thereto.

So far, a method for preventing duplicate training of a linear regression model according to some embodiments of the present disclosure has been described with reference to FIGS. 9 to 12. According to the above, redundant training may be prevented by storing the learned parameters of the linear regression model obtained during the suitability evaluation process of the candidate training set in the storage and reusing them later. Accordingly, computing costs for building a linear regression model, selecting a training set, etc. may be greatly reduced.

Hereinafter, an exemplary computing device 130 capable of implementing the above-described prediction system 10 will be described.

FIG. 13 is an exemplary hardware configuration diagram showing the computing device 130.

As shown in FIG. 13, the computing device 130 may comprise one or more processors 131, a bus 133, a communication interface 134, a memory 132 loading a computer program executed by the processor 131, and a storage 135 that stores a computer program 136. However, only components related to the embodiment of the present disclosure are shown in FIG. 13. Accordingly, a person skilled in the art to which this disclosure pertains may see that other general-purpose components may be included in addition to the components shown in FIG. 13. That is, the computing device 130 may further include various components in addition to those shown in FIG. 13. Additionally, in some cases, the computing device 130 may be configured with some of the components shown in FIG. 13 omitted. Hereinafter, each component of the computing device 130 will be described.

The processor 131 may control the overall operation of each component of the computing device 130. The processor 131 may comprise at least one of a Central Processing Unit (CPU), Micro Processor Unit (MPU), Micro Controller Unit (MCU), Graphic Processing Unit (GPU), or any type of processor well known in the art of the present disclosure. Additionally, the processor 131 may perform operations on at least one application or program to execute operations/methods according to embodiments of the present disclosure. The computing device 130 may include one or more processors.

Next, the memory 132 may store various data, commands and/or information. The memory 132 may load a computer program 136 from storage 135 to execute operations/methods according to embodiments of the present disclosure. The memory 132 may be implemented as a volatile memory such as RAM, but the technical scope of the present disclosure is not limited thereto.

Next, the bus 133 may provide communication functionality between components of the computing device 130. The bus 133 may be implemented as various types of buses, such as an address bus, a data bus, and a control bus.

Next, the communication interface 134 may support wired or wireless internet communication of the computing device 130. Additionally, the communication interface 134 may support various communication methods other than internet communication. To this end, the communication interface 134 may be configured to include a communication module well known in the technical field of the present disclosure.

Next, the storage 135 may non-transitory store one or more computer programs 136. The storage 135 may comprise a non-volatile memory such as Read Only Memory (ROM), Erasable Programmable ROM (EPROM), Electrically Erasable Programmable ROM (EEPROM), flash memory, a hard disk, a removable disk, or any known type of computer-readable recording medium well known in the art to which this disclosure pertains.

Next, the computer program 136 may include one or more instructions that, when loaded into the memory 132, cause the processor 131 to perform operations/methods according to various embodiments of the present disclosure. That is, the processor 131 may perform operations/methods according to various embodiments of the present disclosure by executing one or more loaded instructions.

For example, the computer program 136 may comprises instructions for performing operations comprising obtaining a time series dataset through monitoring usage of storage resource, extracting a plurality of candidate training sets from the time series dataset, evaluating suitability of the plurality of candidate training sets to a linear regression model, selecting a training set from the plurality of candidate training sets based on the evaluation result, and predicting future usage of the storage resource through the linear regression model trained with the training set. In this case, the prediction system 10 according to some embodiments of the present disclosure may be implemented through the computing device 130.

So far, the exemplary computing device 130 capable of implementing the prediction system 10 according to some embodiments of the present disclosure has been described with reference to FIG. 13.

So far, various embodiments of the present disclosure and effects according to the embodiments have been mentioned with reference to FIGS. 1 to 13.

According to some embodiments of the present disclosure, future usage of storage resources may be accurately predicted through a linear regression model with a time variable and a usage variable. This is because storage resource usage usually tends to increase linearly.

Further, by rebuilding the linear regression model periodically or aperiodically, prediction accuracy for future usage may be maintained at a consistently high level.

Further, the training set may be selected (determined) based on the evaluation result of the suitability of the candidate training set for the linear regression model. In this case, because a linear regression model may be trained using a relatively high-quality dataset, prediction accuracy for future usage may be further improved.

Further, duplicate training may be prevented by storing the learned parameters of the linear regression model obtained during the suitability evaluation process of the candidate training set in a storage and reusing them later. Accordingly, computing costs for building a linear regression model, selecting a training set, etc. may be greatly reduced.

The effects according to the technical idea of the present disclosure are not limited to the effects mentioned above, and other effects not mentioned may be clearly understood by those skilled in the art from the description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for predicting usage for cloud storage service performed by at least one computing device, the method comprising:
obtaining a time series dataset through monitoring usage of storage resource;
extracting a plurality of candidate training sets from the time series dataset;
evaluating suitability of the plurality of candidate training sets to a linear regression model, wherein an independent variable of the linear regression model comprises a time variable and a dependent variable represents usage of the storage resource;
selecting a training set from the plurality of candidate training sets based on the evaluation result; and
predicting future usage of the storage resource through the linear regression model trained with the training set.

2. The method of claim 1, wherein the extracting the plurality of candidate training sets comprises:
dividing the time series dataset into a plurality of partial datasets;
extracting the most recent partial dataset among the plurality of partial datasets as a first candidate training set; and
extracting other partial dataset different from the most recent partial dataset as a second candidate training set.

3. The method of claim 2, wherein the other partial dataset is a neighboring dataset of the most recent partial dataset.

4. The method of claim 2, wherein the evaluating the suitability of the plurality of candidate training sets comprises:
evaluating suitability of the first candidate training set using a linear regression model for evaluation trained with the first candidate training set;
additionally training the linear regression model for evaluation with the other partial dataset; and
evaluating suitability of the second candidate training set using the additionally trained linear regression model.

5. The method of claim 1, wherein suitability of each of the plurality of candidate training sets is evaluated based on a determination coefficient of a linear regression model for evaluation trained with a candidate training set.

6. The method of claim 1, wherein the evaluating the suitability of the plurality of candidate training sets comprises:
evaluating suitability of a specific candidate training set based on a residual of a linear regression model for evaluation for the specific candidate training set.

7. The method of claim 6, wherein the evaluating the suitability of the specific candidate training set comprises:
training the linear regression model for evaluation using a first partial dataset of the specific candidate training set; and
calculating a residual of the linear regression model for evaluation using a second partial data set of the specific candidate training set different from the first partial data set.

8. The method of claim 1, wherein the training set is a first training set selected from a first time series dataset generated through monitoring up to a first time point,
wherein the linear regression model is a first linear regression model for predicting future usage after the first time point,
the method further comprises:
selecting a second training set from a second time series dataset obtained through monitoring up to a second time point after the first time point, wherein the second time series dataset comprises additional dataset generated through monitoring after the first time point; and
predicting future usage after the second time point through a second linear regression model trained with the second training set.

9. The method of claim 8, wherein learned parameters of a linear regression model for evaluation obtained during a process of determining the first training set are stored in a storage,
wherein the selecting the second training set comprises:
updating the learned parameters by learning the additional dataset;
selecting the second training set by evaluating suitability of candidate training sets using the updated parameters; and
storing the updated parameters in the storage.

10. The method of claim 1, wherein the predicting the future usage comprises:
predicting usage of the storage resource at a future time point by inputting a value indicating the future time point into the trained linear regression model.

11. The method of claim 1, wherein the predicting the future usage comprises:
predicting a time point when future usage of the storage resource reaches a specific amount through the trained linear regression model.

12. The method of claim 1, wherein the training set is a dataset for a specific client,
wherein the predicting the future usage comprises:
predicting a time point when future usage of the storage resource allocated to the specific client reaches an allocated amount through the trained linear regression model; and
allocating additional storage resource to the specific client before the predicted time point.

13. A system for predicting usage for a cloud storage service comprising:
one or more processors; and
a memory for storing instructions,
wherein the one or more processors, by executing the stored instructions, perform operations comprising:
obtaining a time series dataset through monitoring usage of storage resource;
extracting a plurality of candidate training sets from the time series dataset:
evaluating suitability of the plurality of candidate training sets to a linear regression model, wherein an independent variable of the linear regression model comprises a time variable and a dependent variable represents usage of the storage resource;
determining at least one training set from the plurality of candidate training sets based on the evaluation result; and
predicting future usage of the storage resource through the linear regression model trained with the at least one training set.

14. The system of claim 13, wherein the extracting the plurality of candidate training sets comprises:
dividing the time series dataset into a plurality of partial datasets;
extracting the most recent partial dataset among the plurality of partial datasets as a first candidate training set; and
extracting other partial dataset different from the most recent partial dataset as a second candidate training set.

15. The system of claim 13, wherein suitability of each of the plurality of candidate training sets is evaluated based on a determination coefficient of a linear regression model for evaluation trained with a candidate training set.

16. The system of claim 13, wherein the evaluating the suitability of the plurality of candidate training sets comprises:
evaluating suitability of a specific candidate training set based on a residual of a linear regression model for evaluation for the specific candidate training set.

17. The system of claim 13, wherein the predicting the future usage comprises:
predicting usage of the storage resource at a future time point by inputting a value indicating the future time point into the trained linear regression model; and
predicting a time point when future usage of the storage resource reaches a specific amount through the trained linear regression model.

18. A computer program combined with a computing device,
wherein the computer program is stored on a computer-readable recording medium for executing steps comprising:
obtaining a time series dataset through monitoring usage of storage resource;
extracting a plurality of candidate training sets from the time series dataset;
evaluating suitability of the plurality of candidate training sets to a linear regression model, wherein an independent variable of the linear regression model comprises a time variable and a dependent variable represents usage of the storage resource;
determining at least one training set from the plurality of candidate training sets based on the evaluation result; and
predicting future usage of the storage resource through the linear regression model trained with the at least one training set.
